(19) United States
(12) Patent Application Publication
(10) Pub. No.: US 2021/0334904 A1
(43) Pub. Date: Oct. 28, 2021

(54) INSURANCE GUIDANCE SYSTEM AND METHOD FOR AUTONOMOUS VEHICLE

(71) Applicant: LG Electronics Inc., Seoul (KR)

(72) Inventor: Soryoung KIM, Seoul (KR)

(21) Appl. No.: 16/485,097

(22) PCT Filed: May 3, 2019
(86) PCT No.: PCT/KR2019/005356

§ 371 Date: Aug. 9, 2019

(51) Int. Cl. G06Q 40/08; G01C 21/34; G01C 21/36

(52) U.S. Cl. CPC G06Q 40/08; G01C 21/3461; G01C 21/362; G01C 21/3691; G01C 21/3697

(57) ABSTRACT

Disclosed are an insurance guidance system and method for an autonomous vehicle. The insurance guidance system includes a user terminal for inputting a destination and a safety grade of the vehicle; and a server for transmitting insurance related information of each section of two or more existing sections on a driving route to the destination to the user terminal. Therefore, by providing a danger level of each section so that a user recognizes in advance a danger section on a driving route, an accident can be prevented, and when an accident occurs, a user's damage can be compensated with an appropriate insurance premium. At least one of an autonomous vehicle, a user terminal, and a server may be connected to or fused with an Artificial Intelligence (AI) module, a drone (Unmanned Aerial Vehicle (UAV)), a robot, an augmented reality (AR) device, a virtual reality (VR) device, and a device related to a 5G service.

### TECHNICAL FIELD

The present invention relates to an insurance guidance system and method, and more particular, to an insurance guidance system and method for an autonomous vehicle that guides insurance necessary for each section on a route and that updates insurance guide based on real time monitoring of a danger section.

### BACKGROUND ART

Autonomous vehicles are capable of driving themselves without a driver's intervention. Many companies have already entered an autonomous vehicle project and engaged in research and development.

Autonomous vehicles can support an automatic parking service that finds and parks an empty space without a driver's intervention.

### DISCLOSURE

### Technical Problem

Automobile insurance is insurance that pays an insurance premium to an insurance company so as to relieve anxiety about a car accident and that pays compensation for human and material damages in the event of an accident and that economically relieves victims. However, in the case of existing automobile insurance, insurance information is insufficient and insurable insurance is limited.

Recently, increase of autonomous vehicles makes improvement of existing automobile insurance to an urgent problem. Existing automobile insurance may cause various legal problems because they do not consider a status of autonomous vehicles.

Due to autonomous vehicles, a concept of vehicles is changing from a concept of ownership to a concept of sharing, but the existing automobile insurance does not reflect a usage rate of autonomous vehicles because it is contracted on a yearly basis. For example, as autonomous vehicle technology develops, a time for a driver to directly control the autonomous vehicle is decreasing, but the existing automobile insurance does not reflect such a usage rate of the autonomous vehicle. Owners of autonomous vehicles have less time to directly drive the vehicle, but pay an insurance premium on a yearly basis.

In the case of autonomous vehicles, there is a great difference in a type and frequency of accidents according to a capability of the vehicle to detect a peripheral danger level and a specification of a provided safety device and thus it is necessary to reflect such a difference to automobile insurance.

An object of the present invention is to solve the above-described needs and/or problems.

The object of the present invention is not limited to the above-described objects and the other objects will be understood by those skilled in the art from the following description.

### Technical Solution

An insurance guidance system for an autonomous vehicle according to at least one embodiment of the present invention includes a user terminal for inputting a destination and a safety grade of the vehicle; and a server for transmitting insurance related information of each section of two or more existing sections on a driving route to the destination to the user terminal.

At least one of the user terminal and the vehicle displays a danger section and insurance of each section selected on the driving route.

An method of guiding insurance according to at least one embodiment of the present invention includes inputting a destination and a safety grade of a vehicle to a user terminal; transmitting, by a server, insurance related information of each section of two or more existing sections on a driving route to the destination to the user terminal; and displaying, by at least one of the user terminal and the vehicle, a danger section and insurance of each section selected on the driving route.

### Advantageous Effects

According to the present invention, by providing a danger level of each section so that a user recognizes in advance a danger section on a driving route, an accident can be prevented and when an accident occurs, the user's damage can be compensated with an appropriate insurance premium.

According to the present invention, a safety device specification of an autonomous vehicle can be provided to a user, and the user can select an autonomous vehicle and an insurance product and an insurance premium according to use of a safety device in consideration of use of a safety device.

According to an insurance guidance system and method of the present invention, by applying differential insurance premiums according to a safety grade of the vehicle, a user can pay an appropriate insurance premium according to a safety level of an autonomous vehicle and a possibility of an accident can be lowered.

An insurance guidance system and method of the present invention can provide a safety grade of the vehicle and each section danger of a driving route to a user. Whenever a section is changed, the present invention can update in real time section danger and notify the user of updated section danger to prevent an accident and enable the user to select an appropriate insurance premium at each section, thereby reducing unnecessary waste of insurance premiums.

The effects of the present invention are not limited to the above-described effects and the other effects will be understood by those skilled in the art from the description of claims.

### DESCRIPTION OF DRAWINGS

FIG. 1 illustrates an example of a basic operation of an autonomous vehicle and a 5G network in a 5G communication system.

FIG. 2 illustrates an example of an application operation of an autonomous vehicle and a 5G network in a 5G communication system.

FIGS. 3 to 6 illustrate an example of an operation of an autonomous vehicle using 5G communication.

FIG. 7 is a diagram illustrating an external shape of a vehicle according to an embodiment of the present invention.

FIG. 8 is a diagram illustrating a vehicle when viewed in various angles of the outside according to an embodiment of the present invention.

FIGS. 9 and 10 are diagrams illustrating the inside of a vehicle according to an embodiment of the present invention.

FIGS. 11 and 12 are diagrams illustrating examples of objects related to driving of a vehicle according to an embodiment of the present invention;

FIG. 13 is a block diagram illustrating in detail a vehicle according to an embodiment of the present invention;

FIG. 14 is a diagram illustrating an insurance guidance system according to an embodiment of the present invention.

FIG. 15 is a diagram illustrating a method of guiding insurance of each section on a route and a safety grade using an UX screen displayed on a screen of a user terminal.

FIG. 16 is a table illustrating an example of a method of guiding a safety level, an insurance type, and recommended insurance of each section.

FIG. 17 is a diagram illustrating an example of an insurance guide screen of each section of a driving route on a map.

FIG. 18 is a flowchart illustrating a vehicle calling method.

FIG. 19 is a flowchart illustrating an example of a method of guiding insurance when a danger section is changed.

FIG. 20 is a flowchart illustrating an example of a method of guiding insurance when a driving mode of a vehicle is changed.

FIG. 21 is a flowchart illustrating an example of an insurance application and cancellation method while a vehicle is driven.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

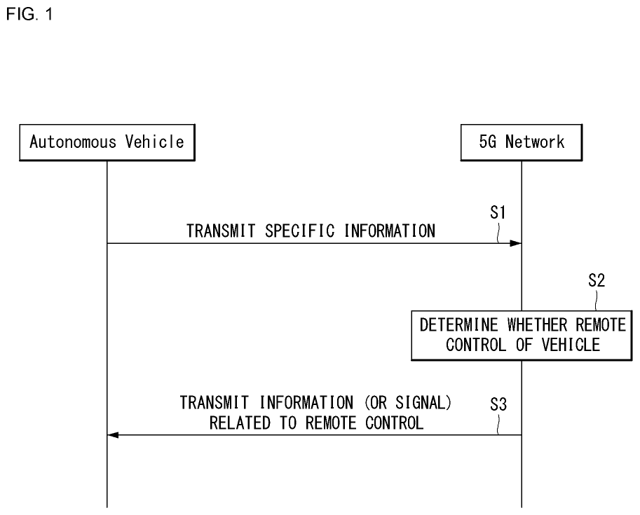

FIG. 1 illustrates an example of a basic operation of an autonomous vehicle and a 5G network in a 5G communication system.

The autonomous vehicle transmits specific information to the 5G network (S1).

The specific information may include autonomous driving related information.

The autonomous driving related information may be information directly related to driving control of the vehicle. For example, the autonomous driving related information may include at least one of object data indicating an object at a periphery of the vehicle, map data, vehicle status data, vehicle position data, and driving plan data.

The autonomous driving related information may further include service information necessary for autonomous driving. For example, the specific information may include information on a destination and a safety grade of the vehicle input through a user terminal. The 5G network may determine whether the remote control of the vehicle (S2).

Here, the 5G network may include a server or a module for performing the autonomous driving related remote control.

The 5G network may transmit information (or signal) related to the remote control to the autonomous vehicle (S3).

As described above, information related to the remote control may be a signal directly applied to the autonomous vehicle and may further include service information required for autonomous driving. In an embodiment of the present invention, the autonomous vehicle may receive service information such as a danger section and each section insurance selected on a driving route through a server connected to the 5G network to provide a service related to autonomous driving.

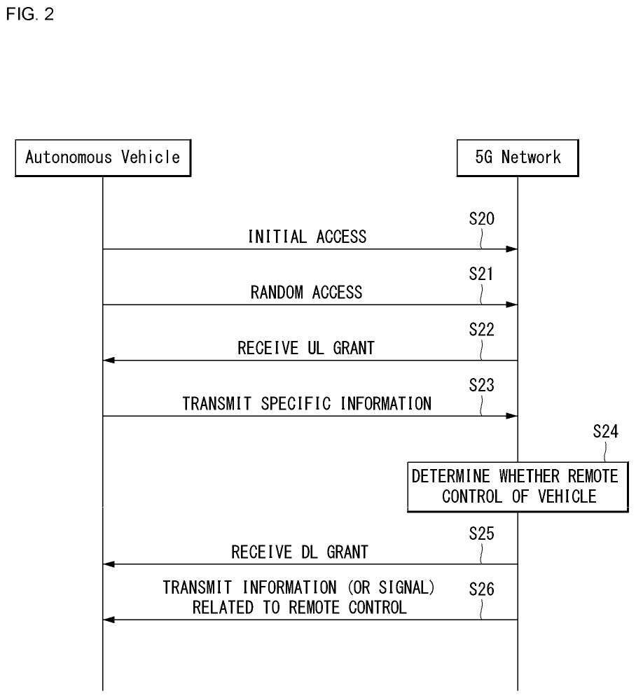

Hereinafter, in FIGS. 2 to 6, in order to provide an insurance service that may be applied to each section in an autonomous driving process according to an embodiment of the present invention, a required process (e.g., an initial access procedure between the vehicle and the 5G network) for 5G communication between the autonomous vehicle and the 5G network is described.

FIG. 2 illustrates an example of an application operation of an autonomous vehicle and a 5G network in a 5G communication system.

The autonomous vehicle performs an initial access procedure with the 5G network (S20).

The initial access procedure includes a process for obtaining system information and cell search for obtaining a downlink (DL) operation.

The autonomous vehicle performs a random access procedure with the 5G network (S21).

The random access process includes preamble transmission and random access response reception processes for uplink (UL) synchronization acquisition or UL data transmission.

The 5G network transmits UL grant for scheduling transmission of specific information to the autonomous vehicle (S22).

The UL grant reception includes a process of receiving time/frequency resource scheduling for transmission of UL data to the 5G network.

The autonomous vehicle transmits specific information to the 5G network based on the UL grant (S23).

The 5G network determines whether the remote control of the vehicle (S24).

In order to receive a response to specific information from the 5G network, the autonomous vehicle receives DL grant through a physical downlink control channel (S25).

The 5G network transmits information (or signal) related to the remote control to the autonomous vehicle based on the DL grant (S26).

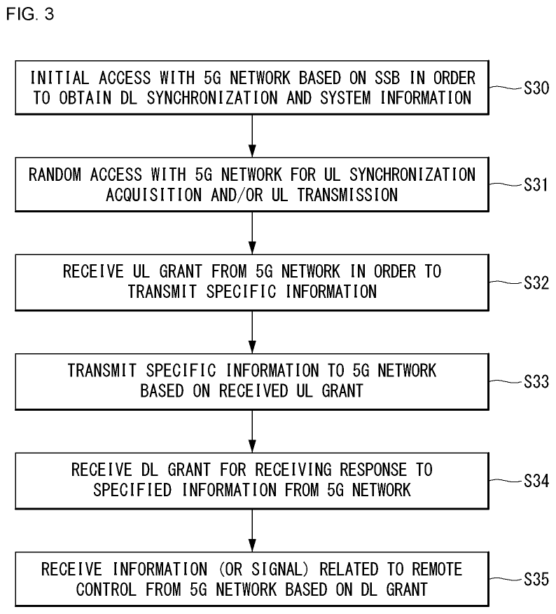

FIG. 3 illustrates an example in which an initial access process and/or a random access process and a DL grant reception process of an autonomous vehicle and 5G communication are coupled through processes of S20 to S26, but the present invention is not limited thereto.

For example, the initial access process and/or the random access process may be performed through the processes of S20, S22, S23, and S24. Further, for example, the initial access process and/or the random access process may be performed through processes of S21, S22, S23, S24, and S26. Further, a coupling process of an AI operation and a DL grant reception process may be performed through S23, S24, S25, and S26.

Further, FIG. 2 illustrates an autonomous vehicle operation through S20 to S26, and the present invention is not limited thereto.

For example, in the autonomous vehicle operation, S20, S21, S22, and S25 may be selectively coupled to S23 and S26 and be operated. Further, for example, the autonomous vehicle operations may be configured with S21, S22, S23, and S26.

Further, for example, the autonomous vehicle operations may be configured with S20, S21, S23, and S26. Further, for example, the autonomous vehicle operations may be configured with S22, S23, S25, and S26.

FIGS. 3 to 6 illustrate an example of an autonomous vehicle operation using 5G communication.

Referring to FIG. 3, in order to obtain DL synchronization and system information, the autonomous vehicle including an autonomous module performs an initial access procedure with the 5G network based on a synchronization signal block (SSB) (S30).

The autonomous vehicle performs a random access procedure with the 5G network for UL synchronization acquisition and/or UL transmission (S31).

In order to transmit specific information, the autonomous vehicle receives UL grant from the 5G network (S32).

The autonomous vehicle transmits specific information to the 5G network based on the UL grant (S33).

The autonomous vehicle receives DL grant for receiving a response to the specified information from the 5G network (S34).

The autonomous vehicle receives information (or signal) related to the remote control from the 5G network based on DL grant (S35).

A Beam Management (BM) process may be added to S30, a beam failure recovery process related to physical random access channel (PRACH) transmission may be added to S31, a QCL relationship may be added to S32 in relation to a beam reception direction of a physical downlink control channel (PDCCH) including UL grant, and a QCL relationship may be added to S33 in relation to a beam transmission direction of a physical uplink control channel (PUCCH)/physical uplink shared channel (PUSCH) including specific information. Further, a QCL relationship may be added to S34 in relation to a beam reception direction of the PDCCH including DL grant.

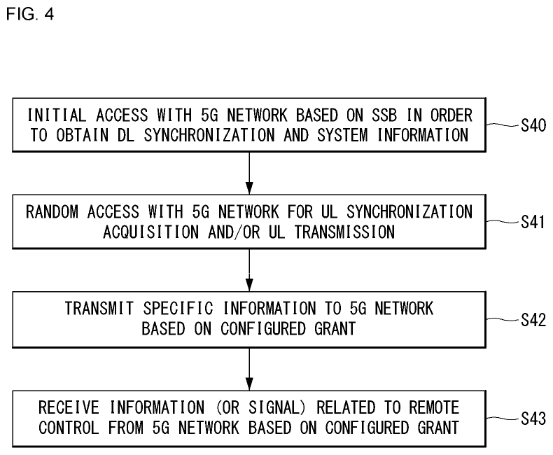

Referring to FIG. 4, in order to obtain DL synchronization and system information, the autonomous vehicle performs an initial access procedure with the 5G network based on the SSB (S40).

The autonomous vehicle performs a random access procedure with the 5G network for UL synchronization acquisition and/or UL transmission (S41).

The autonomous vehicle transmits specific information to the 5G network based on configured grant (S42).

The autonomous vehicle receives information (or signal) related to the remote control from the 5G network based on the configured grant (S43).

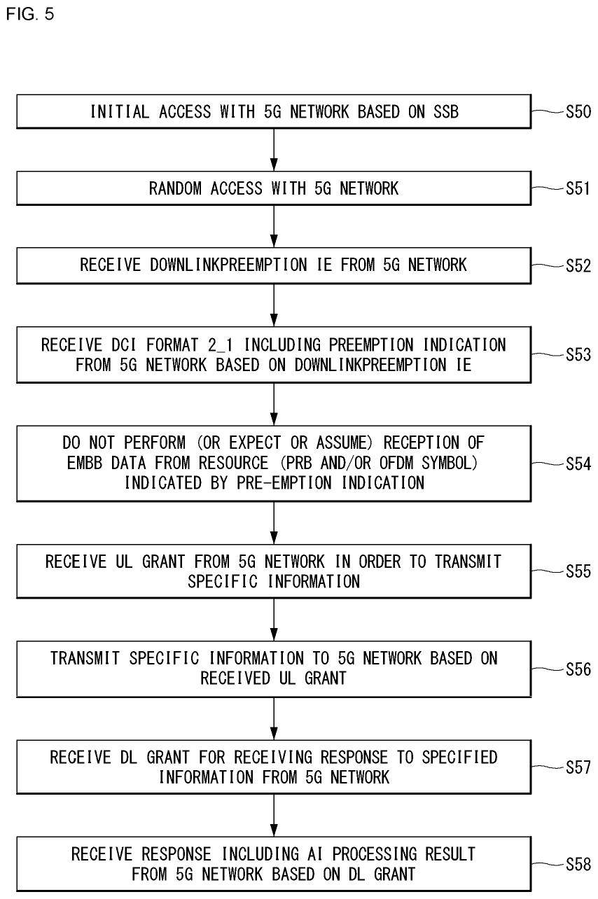

Referring to FIG. 5, in order to obtain DL synchronization and system information, the autonomous vehicle performs an initial access procedure with the 5G network based on the SSB (S50).

The autonomous vehicle performs a random access procedure with the 5G network for UL synchronization acquisition and/or UL transmission (S51).

The autonomous vehicle receives DownlinkPreemption IE from the 5G network (S52).

The autonomous vehicle receives a DCI format 2_1 including a preemption indication from the 5G network based on the DownlinkPreemption IE (S53).

The autonomous vehicle does not perform (or expect or assume) reception of eMBB data from a resource (PRB and/or OFDM symbol) indicated by the pre-emption indication (S54).

In order to transmit specific information, the autonomous vehicle receives UL grant from the 5G network (S55).

The autonomous vehicle transmits specific information to the 5G network based on the UL grant (S56).

The autonomous vehicle receives DL grant for receiving a response to the specified information from the 5G network (S57).

The autonomous vehicle receives information (or signal) related to the remote control from the 5G network based on DL grant (S58).

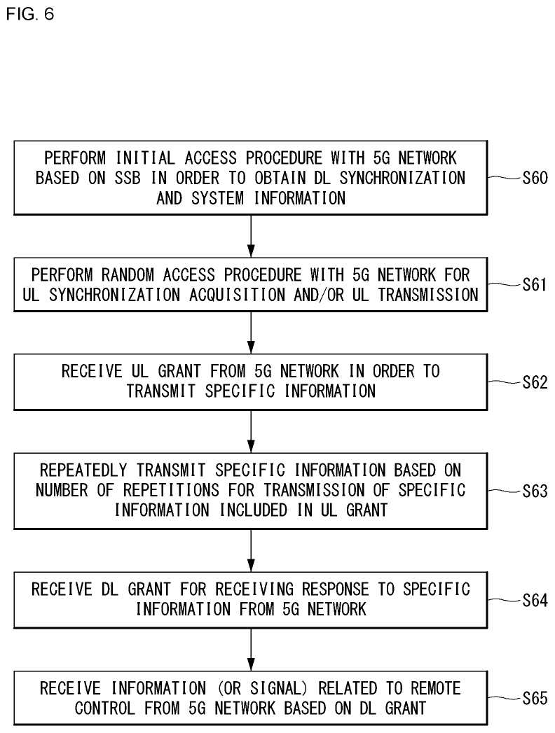

Referring to FIG. 6, in order to obtain DL synchronization and system information, the autonomous vehicle performs an initial access procedure with the 5G network based on the SSB (S60).

The autonomous vehicle performs a random access procedure with the 5G network for UL synchronization acquisition and/or UL transmission (S61).

In order to transmit specific information, the autonomous vehicle receives UL grant from the 5G network (S62).

The UL grant includes information on the number of repetitions of transmission of the specific information, and the specific information is repeatedly transmitted based on the information on the repetition number (S63).

The autonomous vehicle transmits specific information to the 5G network based on the UL grant.

Repeated transmission of specific information is performed through frequency hopping, first specific information may be transmitted in a first frequency resource, and second specific information may be transmitted in a second frequency resource.

The specific information may be transmitted through a narrowband of 6 resource blocks (RB) or 1RB.

The autonomous vehicle receives DL grant for receiving a response to specific information from the 5G network (S64).

The autonomous vehicle receives information (or signal) related to the remote control from the 5G network based on DL grant (S65).

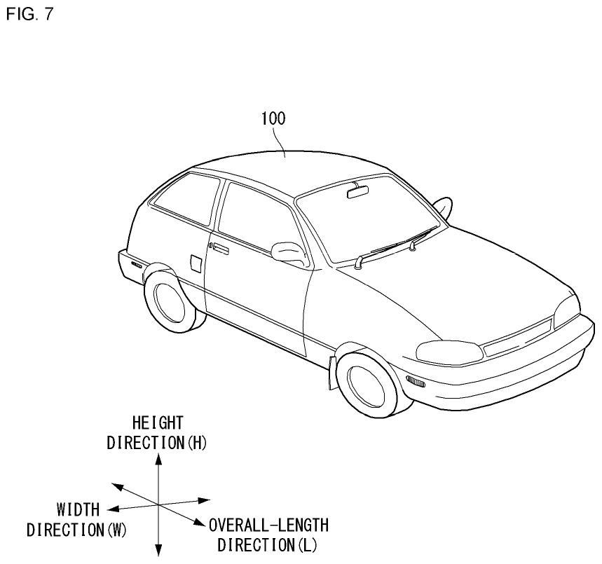

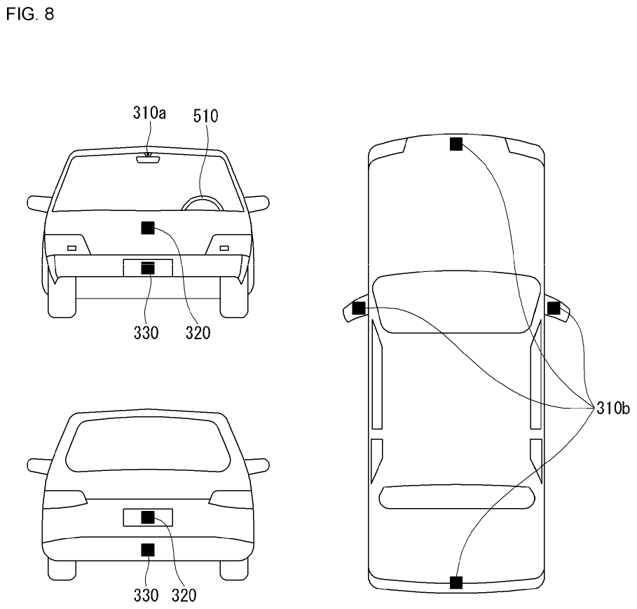

The foregoing 5G communication technology may be applied in combination with methods proposed in the present specification to be described later in FIGS. 7 to 21 or may be supplemented for specifying or for clearly describing technical characteristics of the methods proposed in the present specification.

A vehicle described in the present specification may be connected to an external server through a communication network and move along a preset route without a driver's intervention using autonomous driving technology. The vehicle of the present invention may be implemented into an internal combustion vehicle having an engine as a power source, a hybrid vehicle having an engine and an electric motor as a power source, and an electric vehicle having an electric motor as a power source.

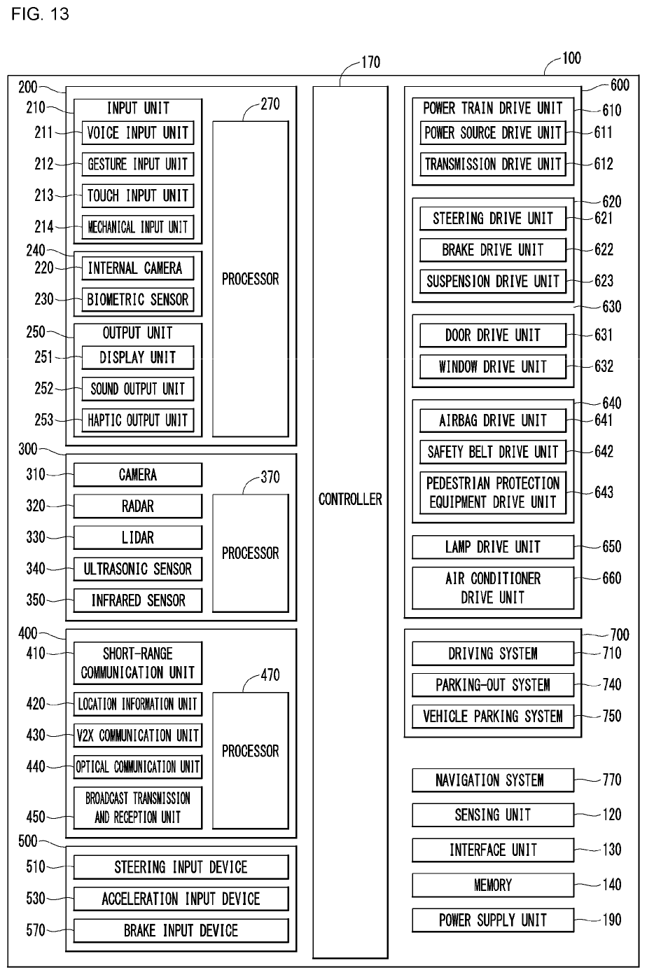

In the following embodiments, the user may be interpreted as a driver, a passenger, or an owner of a user terminal. The user terminal may be a mobile terminal, for example, a smart phone in which a user may carry and that may execute a phone call and various applications, but it is not limited thereto. For example, the user terminal may be interpreted as a mobile terminal, a Personal computer (PC), a laptop computer, or an autonomous vehicle system of FIG. 13.

In the autonomous vehicle, an incident type and frequency may greatly vary according to a capability of sensing in real time peripheral danger elements. A route to a destination may include sections having different danger levels by various causes such as weather, terrain characteristics, and traffic congestion. The present invention guides necessary insurance in each segment when the user inputs a destination and updates insurance guidance through danger section monitoring in real time.

At least one of an autonomous vehicle, a user terminal, and a server of the present invention may be connected to or fused with an Artificial Intelligence (AI) module, a drone (Unmanned Aerial Vehicle (UAV)), a robot, an augmented reality (AR) device, a virtual reality (VR) device, and a device related to a 5G service.

For example, the autonomous vehicle may operate in connection with at least one artificial intelligence (AI) and robot included in the vehicle.

For example, the vehicle may mutually operate with at least one robot. The robot may be an Autonomous Mobile Robot (AMR). The mobile robot is capable of moving by itself to be free to move, and has a plurality of sensors for avoiding obstacles during driving to drive while avoiding obstacles. The moving robot may be a flight type robot (e.g., drone) having a flying device. The moving robot may be a wheel type robot having at least one wheel and moving through a rotation of the wheel. The moving robot may be a leg robot having at least one leg and moving using the leg.

The robot may function as a device that supplements convenience of a vehicle user. For example, the robot may perform a function of moving baggage loaded in the vehicle to a final destination of the user. For example, the robot may perform a function of guiding a route to a final destination to a user who gets off the vehicle. For example, the robot may perform a function of transporting a user who gets off the vehicle to a final destination.

At least one electronic device included in the vehicle may communicate with the robot through a communication device.

At least one electronic device included in the vehicle may provide data processed in at least one electronic device included in the vehicle to the robot. For example, at least one electronic device included in the vehicle may provide at least one of object data indicating an object at a periphery of the vehicle, map data, vehicle status data, vehicle position data, and driving plan data to the robot.

At least one electronic device included in the vehicle may receive data processed in the robot from the robot. At least one electronic device included in the vehicle may receive at least one of sensing data generated in the robot, object data, robot status data, robot position data, and movement plan data of the robot.

At least one electronic device included in the vehicle may generate a control signal based on data received from the robot. For example, at least one electronic device included in the vehicle may compare information on the object generated in the object detecting device and information on an object generated by the robot and generate a control signal based on a comparison result. At least one electronic device included in the vehicle may generate a control signal so that interference does not occur between a moving route of the vehicle and a moving route of the robot.

At least one electronic device included in the vehicle may include a software module or a hardware module (hereinafter, artificial intelligence module) that implements artificial intelligence (AI). At least one electronic device included in the vehicle may use data that input the obtained data to the artificial intelligence module and that are output from the artificial intelligence module.

The AI module may perform machine learning of input data using at least one artificial neural network (ANN). The AI module may output driving plan data through machine learning of the input data.

At least one electronic device included in the vehicle may generate a control signal based on data output from the AI module.

According to an embodiment, at least one electronic device included in the vehicle may receive data processed by artificial intelligence from an external device through the communication device. At least one electronic device included in the vehicle may generate a control signal based on data processed by artificial intelligence.

Hereinafter, various embodiments of the present specification will be described in detail with reference to the attached drawings.

Referring to FIGS. 7 to 13, an overall length means a length from the front to the rear of a vehicle 100, a width means a width of the vehicle 100, and a height means a length from a lower portion of a wheel to a loop of the vehicle 100. In FIG. 7, an overall length direction L means a direction to be the basis of overall length measurement of the vehicle 100, a width direction W means a direction to be the basis of width measurement of the vehicle 100, and a height direction H means a direction to be the basis of height measurement of the vehicle 100. In FIGS. 7 to 12, the vehicle is illustrated in a sedan type, but it is not limited thereto.

The vehicle 100 may be remotely controlled by an external device. The external device may be interpreted as a server. When it is determined that the remote control of the vehicle 100 is required, the server may perform the remote control of the vehicle 100.

A driving mode of the vehicle 100 may be classified into a manual mode, an autonomous mode, or a remote control mode according to a subject of controlling the vehicle 100. In the manual mode, the driver may directly control the vehicle to control vehicle driving. In the autonomous mode, a controller 170 and an operation system 700 may control driving of the vehicle 100 without intervention of the driver. In the remote control mode, the external device may control driving of the vehicle 100 without intervention of the driver.

The user may select one of an autonomous mode, a manual mode, and a remote control mode through a user interface device 200.

The vehicle 100 may be automatically switched to one of an autonomous mode, a manual mode, and a remote control mode based on at least one of driver status information, vehicle driving information, and vehicle status information.

The driver status information may be generated through the user interface device 200 to be provided to the controller 170. The driver status information may be generated based on an image and biometric information on the driver detected through an internal camera 220 and a biometric sensor 230. For example, the driver status information may include a line of sight, a facial expression, and a behavior of the driver obtained from an image obtained through the internal camera 220 and driver position information. The driver status information may include biometric information of the user obtained through the biometric sensor 230. The driver status information may represent a direction of a line of sight of the driver, whether drowsiness of the driver, and the driver's health and emotional state.

The vehicle driving information may include position information of the vehicle 100, posture information of the vehicle 100, information on another vehicle OB11 received from the another vehicle OB11, information on a driving route of the vehicle 100, or navigation information including map information.

The vehicle driving information may include a current position of the vehicle 100 on a route to a destination, a type, a position, and a movement of an object existing at a periphery of the vehicle 100, and whether there is a lane detected at a periphery of the vehicle 100. Further, the vehicle driving information may represent driving information of another vehicle 100, a space in which stop is available at a periphery of the vehicle 100, a possibility in which the vehicle and the object may collide, pedestrian or bike information detected at a periphery of the vehicle 100, road information, a signal status at a periphery of the vehicle 100, and a movement of the vehicle 100.

The vehicle driving information may be generated through connection with at least one of an object detection device 300, a communication device 400, a navigation system 770, a sensing unit 120, and an interface unit 130 to be provided to the controller 170.

The vehicle status information may be information related to a status of various devices provided in the vehicle 100. For example, the vehicle status information may include information on a charge status of the battery, information on an operating status of the user interface device 200, the object detection device 300, the communication device 400, a maneuvering device 500, a vehicle drive device 600, and an operation system 700, and information on whether there is abnormality in each device.

The vehicle status information may represent whether a Global Positioning System (GPS) signal of the vehicle 100 is normally received, whether there is abnormality in at least one sensor provided in the vehicle 100, or whether each device provided in the vehicle 100 normally operates.

A control mode of the vehicle 100 may be switched from a manual mode to an autonomous mode or a remote control mode, from an autonomous mode to a manual mode or a remote control mode, or from a remote control mode to a manual mode or an autonomous mode based on object information generated in the object detection device 300.

The control mode of the vehicle 100 may be switched from a manual mode to an autonomous mode or from an autonomous mode to a manual mode based on information received through the communication device 400.

The control mode of the vehicle 100 may be switched from a manual mode to an autonomous mode or from an autonomous mode to a manual mode based on information, data, and a signal provided from an external device.

When the vehicle 100 is driven in an autonomous mode, the vehicle 100 may be driven under the control of the operation system 700. In the autonomous mode, the vehicle 100 may be driven based on information generated in the driving system 710, the parking-out system 740, and the parking system 750.

When the vehicle 100 is driven in a manual mode, the vehicle 100 may be driven according to a user input that is input through the maneuvering device 500.

When the vehicle 100 is driven in a remote control mode, the vehicle 100 may receive a remote control signal transmitted by the external device through the communication device 400. The vehicle 100 may be controlled in response to the remote control signal.

Referring to FIG. 13, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

In addition to the components illustrated in FIG. 13, other components may be further included or some components may be omitted.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensor 230, an output unit 250, and a processor 270.

The input unit 210 is configured to receive a user command from a user, and data collected in the input unit 210 may be analyzed by the processor 270 and then recognized as a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170. The voice input unit 211 may include one or more microphones.

The gesture input unit 212 may convert a gesture input of a user into an electrical signal. The converted electrical signal may be provided to the processor 270 or the controller 170.

The gesture input unit 212 may sense the 3D gesture input. To this end, the gesture input unit 212 may include a plurality of light emitting units for outputting infrared light, or a plurality of image sensors.

The gesture input unit 212 may sense the 3D gesture input by employing a Time of Flight (TOF) scheme, a structured light scheme, or a disparity scheme.

The touch input unit 213 may convert a user's touch input into an electrical signal. The converted electrical signal may be provided to the processor 270 or the controller 170. The touch input unit 213 may include a touch sensor for sensing a touch input of a user. The touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170. The mechanical input unit 214 may be located on a steering wheel, a center fascia, a center console, a cockpit module, a door, etc.

An occupant sensor 240 may detect an occupant in the vehicle 100. The occupant sensor 240 may include the internal camera 220 and the biometric sensor 230.

The internal camera 220 may acquire images of the inside of the vehicle 100. The processor 270 may sense a user's state based on the images of the inside of the vehicle 100.

The processor 270 may acquire information on the eye gaze, the face, the behavior, the facial expression, and the location of the user from an image of the inside of the vehicle 100. The processor 270 may sense a gesture of the user from the image of the inside of the vehicle 100. The processor 270 may provide the driver state information to the controller 170,

The biometric sensor 230 may acquire biometric information of the user. The biometric sensor 230 may include a sensor for acquire biometric information of the user, and may utilize the sensor to acquire finger print information, heart rate information, brain wave information etc. of the user. The biometric information may be used to authenticate a user or determine the user's condition.

The processor 270 may determine a driver's state based on the driver's biometric information. The driver state information may indicate whether the driver is in faint, dozing off, excited, or in an emergency situation. The processor 270 may provide the driver state information, acquired based on the driver's biometric information, to the controller 170.

The output unit 250 is configured to generate a visual, audio, or tactile output. The output unit 250 may include at least one selected from among a display unit 251, a sound output unit 252, and a haptic output unit 253.

The display unit 251 may display an image signal including various types of information. The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213 to implement a touch screen. The display unit 251 may be implemented as a Head Up Display (HUD). When implemented as a HUD, the display unit 251 may include a projector module in order to output information through an image projected on a windshield or a window.

The display unit 251 may include a transparent display. The transparent display may be attached on the windshield or the window. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

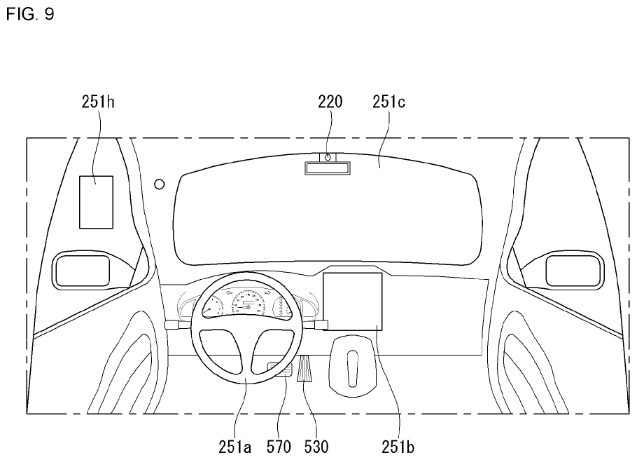

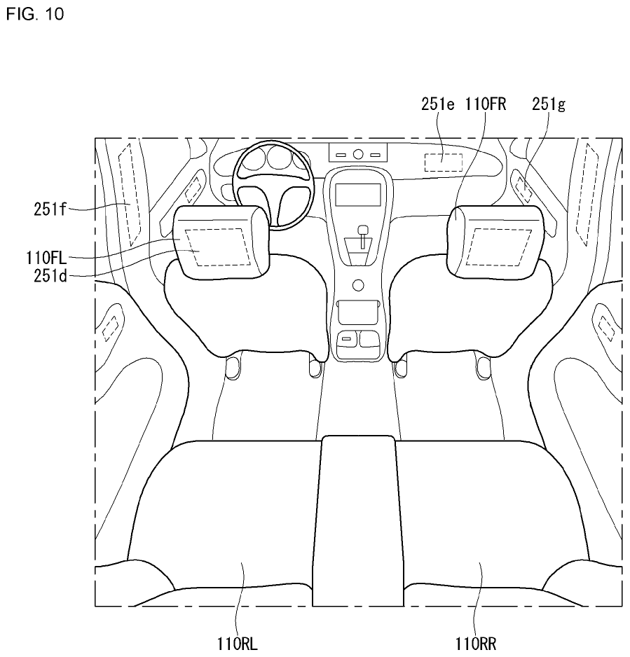

The display unit 251 may include a plurality of displays 251a to 251g as shown in FIGS. 9 and 10. The display unit 251 may be disposed in a region 251a of a steering wheel, a region 251b or 251e of an instrument panel, a region 251d of a seat, a region 251f of each pillar, a region 251g of a door, a region of a center console, a region of a head lining, a region of a sun visor, a region 251c of a windshield, or a region 251h of a window. The display 251h disposed in the window may be disposed in each of the front window, the rear window, and the side window of the vehicle 100.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200. In a case where the user interface device 200 does not include the processor 270, the user interface device 200 may operate under control of the controller 170 or a processor of a different device inside the vehicle 100.

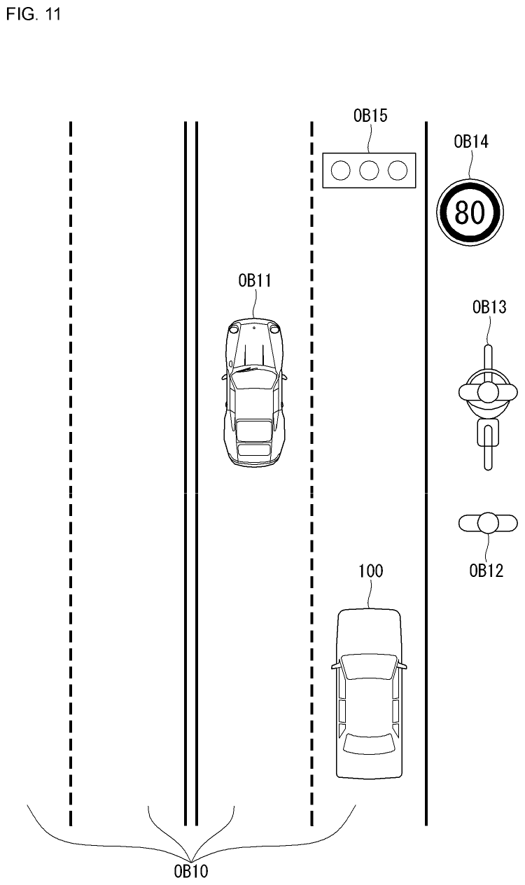

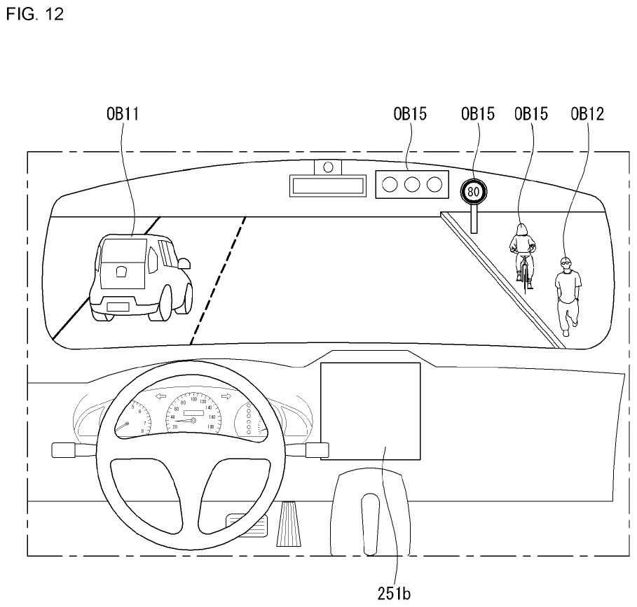

The object detection device 300 is configured to detect an object outside the vehicle 100. The object may include various objects related to travelling of the vehicle 100. For example, referring to FIGS. 11 and 12, an object o may include a lane OB10, a nearby vehicle OB11, a pedestrian OB12, a two-wheeled vehicle OB13, a traffic sign OB14 and OB15, a light, a road, a structure, a bump, a geographical feature, an animal, etc.

The lane OB10 may be a lane in which the vehicle 100 is traveling, a lane next to the lane in which the vehicle 100 is traveling, or a lane in which a different vehicle is travelling from the opposite direction. The lane OB10 may include left and right lines that define the lane.

The nearby vehicle OB11 may be a vehicle that is travelling in the vicinity of the vehicle 100. The nearby vehicle OB11 may be a vehicle within a predetermined distance from the vehicle 100. For example, the nearby vehicle OB11 may be a vehicle that is travelling ahead or behind the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic sign may include a traffic light OB15, a traffic sign plate OB14, and a pattern or text painted on a road surface.

The light may be light generated by a lamp provided in the nearby vehicle. The light may be light generated by a street light. The light may be solar light.

The road may include a road surface, a curve, and slopes, such as an upward slope and a downward slope.

The structure may be a body located around the road in the state of being fixed onto the ground. For example, the structure may include a streetlight, a roadside tree, a building, a bridge, a traffic light, a curb, a guardrail, etc.

The geographical feature may include a mountain and a hill.

The object may be classified as a movable object or a stationary object. The movable object may include a nearby vehicle and a pedestrian. The stationary object may include a traffic sign, a road, and a fixed structure.

The object detection device 300 may include a camera 310, a radar 320, a lidar 330, an ultrasonic sensor 340, an infrared sensor 350, and a processor 370.

The camera 310 may be located at an appropriate position outside the vehicle 100 in order to acquire images of the outside of the vehicle 100. The camera 310 may be a mono camera, a stereo camera 310a, an Around View Monitoring (AVM) camera 310b, or a 360-degree camera.

The camera 310 may be disposed near a front windshield in the vehicle 100 in order to acquire images of the front of the vehicle 100. The camera 310 may be disposed around a front bumper or a radiator grill. The camera 310 may be disposed near a rear glass in the vehicle 100 in order to acquire images of the rear of the vehicle 100. The camera 310 may be disposed around a rear bumper, a trunk, or a tailgate. The camera 310 may be disposed near at least one of the side windows in the vehicle 100 in order to acquire images of the side of the vehicle 100. The camera 310 may be disposed around a side mirror, a fender, or a door. The camera 310 may provide an acquired image to the processor 370.

The radar 320 may include an electromagnetic wave transmission unit and an electromagnetic wave reception unit. The radar 320 may be realized as pulse radar or continuous wave radar depending on the principle of emission of an electronic wave. The radar 320 may be realized as Frequency Modulated Continuous Wave (FMCW) type radar or Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object. The radar 320 may be located at an appropriate position outside the vehicle 100 in order to sense an object located in front of the vehicle 100, an object located to the rear of the vehicle 100, or an object located to the side of the vehicle 100.

The lidar 330 may include a laser transmission unit and a laser reception unit. The lidar 330 may be implemented by the TOF scheme or the phase-shift scheme. The lidar 330 may be implemented as a drive type lidar or a non-drive type lidar. When implemented as the drive type lidar, the lidar 300 may rotate by a motor and detect an object in the vicinity of the vehicle 100. When implemented as the non-drive type lidar, the lidar 300 may utilize a light steering technique to detect an object located within a predetermined distance from the vehicle 100. The vehicle 100 may include a plurality of non-driven type lidar 330.

The lidar 330 may detect an object through the medium of laser light by employing the TOF scheme or the phase-shift scheme, and may detect a location of the detected object, the distance to the detected object, and the speed relative to the detected object. The lidar 330 may be located at an appropriate position outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a location of the detected object, the distance to the detected object, and the speed relative to the detected object. The ultrasonic sensor 340 may be located at an appropriate position outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 340 may detect an object based on infrared light, and may detect a location of the detected object, the distance to the detected object, and the speed relative to the detected object. The infrared sensor 350 may be located at an appropriate position outside the vehicle 100 in order to sense an object located in front of the vehicle 100, an object located to the rear of the vehicle 100, or an object located to the side of the vehicle 100.

The processor 370 may control the overall operation of each unit of the object detection device 300. The processor 370 may detect and track an object based on acquired images. The processor 370 may calculate the distance to the object and the speed relative to the object, determine a type, location, size, shape, color, moving path of the object, and determine a sensed text.

The processor 370 may detect and track an object based on a reflection electromagnetic wave which is formed as a result of reflection a transmission electromagnetic wave by the object. Based on the electromagnetic wave, the processor 370 may, for example, calculate the distance to the object and the speed relative to the object.

The processor 370 may detect and track an object based on a reflection laser light which is formed as a result of reflection of transmission laser by the object. Based on the laser light, the processor 370 may calculate the distance to the object and the speed relative to the object.

The processor 370 may detect and track an object based on a reflection ultrasonic wave which is formed as a result of reflection of a transmission ultrasonic wave by the object. Based on the ultrasonic wave, the processor 370 may calculate the distance to the object and the speed relative to the object.

The processor 370 may detect and track an object based on reflection infrared light which is formed as a result of reflection of transmission infrared light by the object. Based on the infrared light, the processor 370 may calculate the distance to the object and the speed relative to the object.

The processor 370 may generate object information based on at least one of the following: an information acquired using the camera 310, a reflected electronic wave received using the radar 320, a reflected laser light received using the lidar 330, and a reflected ultrasonic wave received using the ultrasonic sensor 340, and a reflected infrared light received using the infrared sensor 350. The processor 370 may provide the object information to the controller 170.

The object information may be information about a type, location, size, shape, color, a moving path, and speed of an object existing around the vehicle 100 and information about a sensed text. The object information may indicate: whether a traffic line exists in the vicinity of the vehicle 100; whether any nearby vehicle is travelling while the vehicle 100 is stopped; whether there is a space in the vicinity of the vehicle 100 to stop; whether a vehicle and an object could collide; where a pedestrian or a bicycle is located with reference to the vehicle 100; a type of a roadway in which the vehicle 100 is travelling, a status of a traffic light in the vicinity of the vehicle 100, and movement of the vehicle 100.

The object detection device 300 may include a plurality of processors 370 or may not include the processor 370. For example, each of the camera 310, the radar 320, the lidar 330, the ultrasonic sensor 340, and the infrared sensor 350 may include its own processor.

The object detection device 300 may operate under control of the controller 170 or a processor inside the vehicle 100.

The communication device 400 is configured to perform communication with an external device. Here, the external device may be a nearby vehicle, a user's terminal, or a server.

To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, and a processor 470.

The short-range communication unit 410 is configured to perform short-range communication. The short-range communication unit 410 may support short-range communication using at least one selected from among Bluetooth [symbol] , Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus).

The short-range communication unit 410 may form wireless area networks to perform short-range communication between the vehicle 100 and at least one external device.

The location information unit 420 is configured to acquire location information of the vehicle 100. For example, the location information unit 420 may include at least one of a Global Positioning System (GPS) module, a Differential Global Positioning System (DGPS) module, and a Carrier phase Differential GPS (CDGPS) module.

The V2X communication unit 430 is configured to perform wireless communication between a vehicle and a server (that is, vehicle to infra (V2I) communication), wireless communication between a vehicle and a nearby vehicle (that is, vehicle to vehicle (V2V) communication), or wireless communication between a vehicle and a pedestrian (that is, vehicle to pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal. The light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The processor 470 may control the overall operation of each unit of the communication device 400. The processor 470 may generate vehicle driving information based on information received through at least one of a short range communication unit 410, a position information unit 420, a V2X communication unit 430, an optical communication unit 440, and a broadcast transmitting and receiving unit 450. The processor 470 may generate vehicle driving information based on information on a position, model, driving route, speed, and various sensing values of other vehicle received from other vehicle. When information on various sensing values of other vehicle is received, even if there is no separate sensor in the vehicle 100, the processor 470 may obtain information on a peripheral object of the vehicle 100.

In a case where the communication device 400 does not include the processor 470, the communication device 400 may operate under control of the controller 170 or a processor of a device inside of the vehicle 100.

The communication device 400 may implement a vehicle display device, together with the user interface device 200. In this case, the vehicle display device may be referred to as a telematics device or an Audio Video Navigation (AVN) device.

The controller 170 may transmit at least one of driver status information, vehicle status information, vehicle driving information, error information representing an error of the vehicle 100, and object information based on a signal received from the communication device 400, a user input received through the user interface device 200, and a remote control request signal to an external device. The remote control server may determine whether the remote control is required in the vehicle 100 based on information sent by the vehicle 100.

The controller 170 may control the vehicle 100 according to a control signal received from a remote control server through the communication device 400.

The maneuvering device 500 is configured to receive a user command for driving the vehicle 100. In the manual driving mode, the vehicle 100 may operate based on a signal provided by the maneuvering device 500.

The maneuvering device 500 may include a steering input device 510, an acceleration input device 530, and a brake input device 570.

The steering input device 510 may receive a user command for steering of the vehicle 100. The user command for steering may be a command corresponding to a specific steering angle. The steering input device 510 may take the form of a wheel to enable a steering input through the rotation thereof. In some implementations, the steering input device may be provided as a touchscreen, a touch pad, or a button.

The acceleration input device 530 may receive a user command for acceleration of the vehicle 100. The brake input device 570 may receive a user command for deceleration of the vehicle 100. Each of the acceleration input device 530 and the brake input device 570 may take the form of a pedal. In some implementations, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100. The vehicle drive device 600 may include a power train drive unit 610, a chassis drive unit 620, a door/window drive unit 630, a safety apparatus drive unit 640, a lamp drive unit 650, and an air conditioner drive unit 660.

The power train drive unit 610 may control the operation of a power train.

The power train drive unit 610 may include a power source drive unit 611 and a transmission drive unit 612.

The power source drive unit 611 may control a power source of the vehicle 100. In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170.

The transmission drive unit 612 may control a transmission. The transmission drive unit 612 may adjust the state of the transmission. The transmission drive unit 612 may adjust a state of the transmission to a drive (D), reverse (R), neutral (N), or park (P) state. In some implementations, in a case where an engine is the power source, the transmission drive unit 612 may adjust a gear-engaged state to the drive position D.

The chassis drive unit 620 may control the operation of a chassis. The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel. In some implementations, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100. In some implementations, the suspension drive unit 623 may control a plurality of suspensions individually.

The door/window drive unit 630 may perform electronic control of a door device or a window device inside the vehicle 100. The door/window drive unit 630 may include a door drive unit 631 and a window drive unit 632. The door drive unit 631 may control the door device. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window device. The window drive unit 632 may control opening or closing of a plurality of windows included in the vehicle 100.

The safety apparatus drive unit 640 may perform electronic control of various safety apparatuses provided inside the vehicle 100. The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100.

The operation system 700 is a system for controlling the overall operation of the vehicle 100. The operation system 700 may operate in an autonomous mode. In a case where the operation system 700 is implemented as software, the operation system 700 may be a subordinate concept of the controller 170.

The operation system 700 may be a concept including at least one selected from among the user interface device 200, the object detection device 300, the communication device 400, the vehicle drive device 600, and the controller 170.

The driving system 710 may perform driving of the vehicle 100 by providing a control signal to the vehicle drive device 600 in response to reception of navigation information from the navigation system 770. The navigation information may include route information necessary for autonomous travel such as destination and waypoint information. The driving system 710 may provide a control signal to the vehicle drive device 600 in response to reception of object information from the object detection device 300. The driving system 710 may provide a control signal to the vehicle drive device 600 in response to reception of a signal from an external device through the communication device 400.

The parking-out system 740 may park the vehicle 100 out of a parking space. The parking-out system 740 may provide a control signal to the vehicle drive device 600 based on location information of the vehicle 100 and navigation information provided by the navigation system 770. The parking-out system 740 may provide a control signal to the vehicle drive device 600 based on object information provided by the object detection device 300. The parking-out system 740 may provide a control signal to the vehicle drive device 600 based on a signal provided by an external device received through the communication device 400.

The parking system 750 may park the vehicle 100 in a parking space. The vehicle parking system 750 may provide a control signal to the vehicle drive device 600 based on the navigation information provided by the navigation system 770. The parking system 750 may provide a control signal to the vehicle drive device 600 based on object information provided by the object detection device 300. The parking system 750 may provide a control signal to the vehicle drive device 600 based on a signal provided by an external device received through the communication device 400.

The navigation system 770 may provide navigation information. The navigation information may include at least one of the following: map information, information on a set destination, information on a route to the set destination, information on various objects along the route, lane information, and information on the current location of a vehicle. The navigation system 770 may include a memory and a processor. The memory may store navigation information. The processor may control the operation of the navigation system 770. The navigation system 770 may update pre-stored information by receiving information from an external device through the communication device 400. The navigation system 770 may be classified as an element of the user interface device 200.

The sensing unit 120 may sense the state of the vehicle. The sensing unit 120 may include an attitude sensor, a collision sensor, a wheel sensor, a speed sensor, a gradient sensor, a weight sensor, a heading sensor, a yaw sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, and a brake pedal position sensor. For example, the attitude sensor may include yaw sensor, roll sensor, pitch sensor, etc.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, out-of-vehicle illumination information, information about the pressure applied to an accelerator pedal, and information about the pressure applied to a brake pedal.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

The interface 130 may serve as a passage for the supply of electrical energy to a user's terminal connected thereto. When the user's terminal is electrically connected to the interface 130, the interface 130 may provide electrical energy, supplied from the power supply unit 190, to the user's terminal under control of the controller 170.

The memory 140 is electrically connected to the controller 170. The memory 140 may store basic data for each unit, control data for the operational control of each unit, and input/output data. The memory 140 may store various data for the overall operation of the vehicle 100, such as programs for the processing or control of the controller 170. The memory 140 may be any of various hardware storage devices, such as a ROM, a RAM, an EPROM, a flash drive, and a hard drive.

The memory 140 may be integrally formed with the controller 170, or may be provided as an element of the controller 170.

The controller 170 may control overall operation of each unit in the vehicle 100. The controller 170 may be referred to as an Electronic Control Unit (ECU). The controller 170 may control the vehicle 100 based on information obtained through at least one of the object detection device 300 and the communication device 400. Accordingly, the vehicle 100 may perform autonomous driving under the control of the controller 170.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The power supply unit 190 may receive power from a battery in the vehicle. The power supply unit 190 may supply power necessary for an operation of each component to components under the control of the controller 170.

The vehicle 100 may include an In-Vehicle Infotainment (IVI) system. The IVI system may operate in connection with the user interface device 200, the communication device 400, the controller 170, the navigation system 770, and the operation system 700. The IVI system reproduces multimedia contents in response to a user input and executes User Interfaces (UI) or User Experience (UX) program for various application programs.

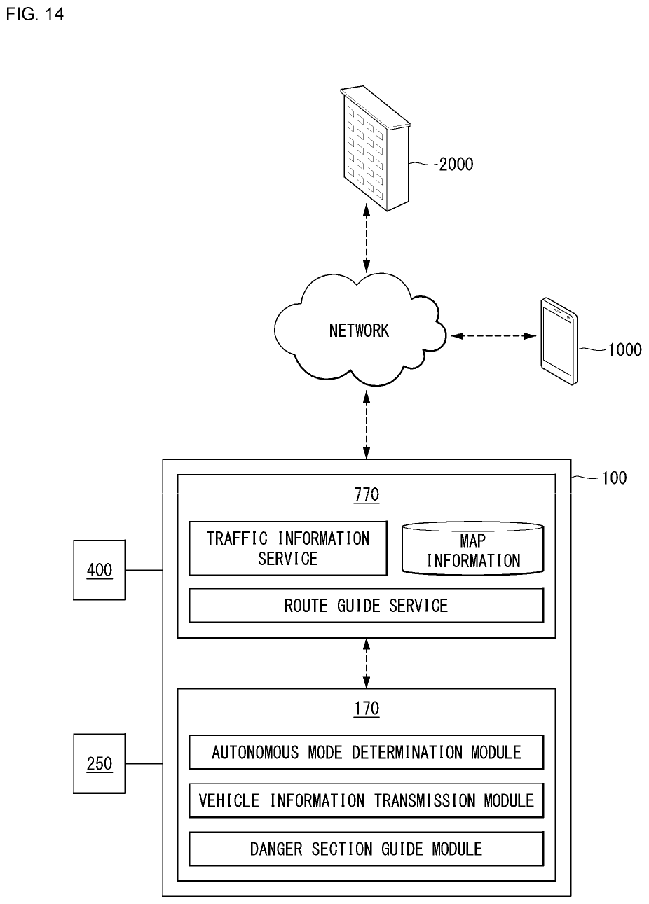

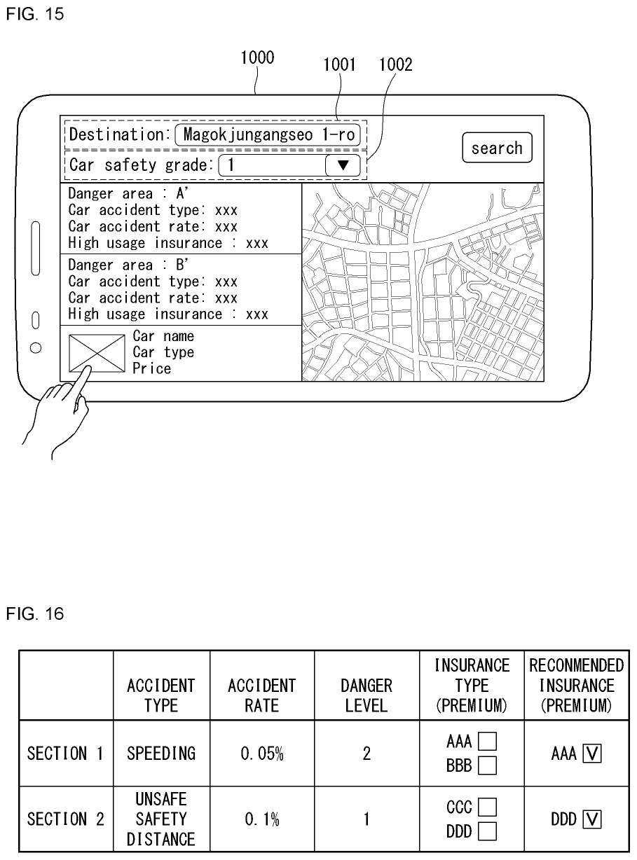

FIG. 14 is a diagram illustrating an insurance guidance system according to an embodiment of the present invention. FIG. 15 is a diagram illustrating a method of guiding insurance of each section on a route and a safety grade using an UX screen displayed on a screen of a user terminal.

Referring to FIG. 14, the insurance guidance system of the present invention includes a vehicle 100, a user terminal 1000, and a server 2000 connected through a network.

The user terminal 1000 executes a car call application according to the user's input. The car call application may be displayed on a screen of the user terminal including a destination input window 1001 and a safety grade input window 1002, as illustrated in FIG. 15.

The insurance guidance system and method of the present invention define a safety grade of a vehicle according to a safety device providing status and option of the vehicle and guide an insurance service according to the safety grade to the user. The higher a safety level of the vehicle, the lower a possibility of an accident to prevent a serious accident and thus an insurance premium may be lowered.

The safety grade may be preset according to a safety device providing status of the vehicle. The safety device of the vehicle is a safety device that can reduce a damage level of a user in the event of a vehicle accident and includes an airbag, a sensor, an Anti-lock Brake System (ABS), a Traction Control System (TCS), an Electronic Stability Program (ESP), and an Electronic Control suspension (ECS), but it is not limited thereto.

For example, the safety grade may be set according to the number and type of the safety device provided in the vehicle, as illustrated below.

Vehicle of safety grade 1: Vehicle with all seat airbags, front and rear sensors, ABS, TCS, ESP, and ECS

Vehicle of safety grade 2: Vehicle with front seat air bags, front and rear sensors, ABS, and TCS

Vehicle of safety grade 3: Vehicle with a driver seat air bag and front and rear sensors

The safety grade may be classified according to a performance of each of safety devices. For example, the safety grade may be different according to a performance of components of the object detecting device 300 for detecting an object at a periphery of the vehicle. For example, the higher a resolution of at least one of the camera 310, the radar 320, the lidar 330, the ultrasonic sensor 340, and the infrared sensor 350, the higher a safety grade of the vehicle, and the longer a detection distance, the higher a safety grade of the vehicle.

When changing a safety device provided when the vehicle 100 is released, a safety performance may be deteriorated. In consideration of this, when a safety device specification is different from a safety device specification when the vehicle 100 is released, a safety grade may be deteriorated.

The server 2000 may analyze a route to the destination received from the user terminal 1000 to transmit section insurance guide information for guiding a danger section, an insurance type, recommended insurance, an insurance premium and the like on the route to the user terminal 1000, as illustrated in FIGS. 15 and 16. The danger section may be represented by section danger, as illustrated in FIG. 16. When the user gets on the vehicle 100, the server 200 may transmit such data to the user terminal 1000 and/or the vehicle 100. The user terminal 1000 and the vehicle 100 may display data received from the server 2000 on an insurance guidance screen.

The server 200 may determine section danger in consideration of an accident type and an accident rate of each section, weather, a time, traffic congestion and the like to set a danger section. The insurance premium may be changed according to section danger. In a section (danger section) having high danger, an insurance premium may be highly set.

For example, a section having a serious accident history may be set to a section of a high danger rating, and a section having a high accident rate may be set to a section of a high safety grade.

The same section may be adjusted to a section of a high danger rating due to fog, rain, and snow. The same section may be adjusted to a section of a high danger rating in the event of a serious accident or at a time of a high accident frequency. Further, when traffic congestion increases at the same section, a rating of the section may be adjusted to a higher danger rating.

The server 2000 may differently guide insurance premiums and insurance types to the user in consideration of a safety grade and various danger factors of the vehicle. For example, in a day of heavy snow, because a vehicle of a safety grade 1 has a TCS, it is unnecessary to guide sliding related insurance. In this case, the server 2000 may not provide insurance guidance or transmit insurance information of simple coverage to the user terminal 1000. However, because a vehicle of a safety grade 3 does not have a TCS, the server 2000 provides sliding related insurance guide information to the user terminal 1000. Accordingly, the user terminal 1000 may display section insurance guidance information received from the server 2000 on the display according to the safety grade and various danger factors.

The user may check insurance guide information of each section displayed on the display of the user terminal 1000 or the vehicle 100, select a driving route and insurance of each section and then call the vehicle 100.

After a drive route and purchase of section insurance are completed, the vehicle 100 may arrive at a pickup location in which the user may get on.

The insurance type may include insurance products provided by each of insurance companies at each section. Further, the insurance type may include strengths and weaknesses of each insurance product.

As recommended insurance, insurance having a high usage rate in each section and insurance used by other users of a safety driving propensity may be selected. Other users of a safety driving propensity may be users having a few accident histories at the corresponding section.

The server 2000 may monitor a danger section in real time and update in real time data indicating section danger to transmit the updated data to the user terminal 100 and/or the vehicle 1000.

When the vehicle 100 enters a section on a driving route based on vehicle information received from the vehicle 100, the server 2000 may pay an insurance premium selected by the user and transmit a payment processing result message to the user terminal 1000 or the vehicle 100. Whenever the vehicle 100 leaves the section, the server 2000 may cancel an insurance contract of the section and transmit a cancellation message to the user terminal 1000 or the vehicle 100.

Whenever a section is changed, the server 2000 transmits insurance guidance information applied to the section. The insurance guidance information may include information on section danger, an insurance type, recommended insurance, an insurance premium, and the like.

When a driving mode of the vehicle 100 is changed based on vehicle information received from the vehicle 100, for example, when a driving mode is changed from an autonomous mode to a manual mode, the server 2000 transmits insurance guidance information applied to the manual mode to the user terminal 100 and/or the vehicle 1000. Therefore, when the user switches from an autonomous mode to a manual mode to directly control driving of the vehicle 100, the server 2000 may update an insurance contract corresponding to the manual mode at each section.

The server 2000 calculates statistics on insurance selected by users at each section, insurance satisfaction, and an accident history, selects recommended section insurance based on the statistics, and transmits the recommended section insurance to a user of a next vehicle at each section.

The insurance guidance system and method of the present invention can differentially apply insurance premiums according to a safety grade of the vehicle to enable the user to appropriately pay an insurance premium according to a safety level of the autonomous vehicle and reduce a possibility of an accident.

The insurance guidance system and method of the present invention may provide a safety grade of the vehicle and each section danger of a driving route to the user. The present invention updates in real time section danger whenever a section is changed, notifies the user the section danger to enable the user to prevent an accident, and enables the user to select an appropriate insurance premium at each section to reduce unnecessary waste of insurance premiums.

The controller 170 of the vehicle 100 may include an autonomous mode determination module, a vehicle information transmission module, and a section danger guide module. The autonomous mode determination module is connected to the object detection device 300 and the operation system 700 to control autonomous driving of the vehicle. The vehicle information transmission module transmits vehicle information including vehicle driving information and vehicle status information to the server 2000 through the communication device 400. The section danger guide module may output section danger received from the server 2000 to the output unit 250 to notify in real time the user of section danger.

The navigation system 770 of the vehicle 100 performs map information, traffic information, and a route guide service. The navigation system 770 displays a driving route selected by the user on a map to guide the route and outputs a real time traffic situation received from the server 2000 through the output unit 250.

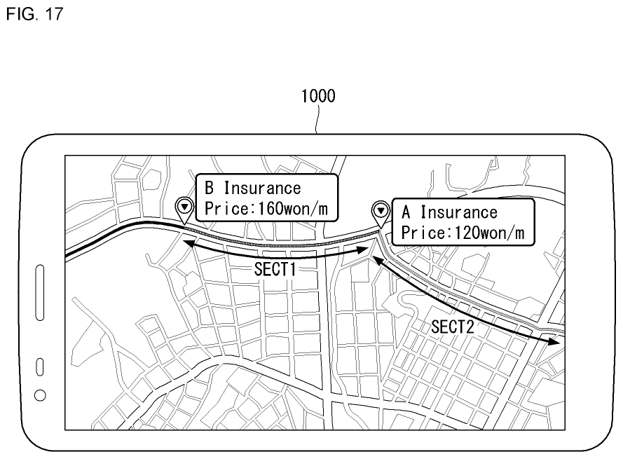

FIG. 17 is a diagram illustrating an example of an insurance guidance screen of each section of a driving route on a map.

Referring to FIG. 17, the display of the user terminal 1000 or the vehicle 100 may display a map in which route information from the navigation system 770 is reflected. In the map, an insurance type and an insurance premium of each section selected by the user on the drive route may be displayed.

For example, as insurance of a first section SECT1, insurance B with an insurance premium of 160 won/m may be selected. As insurance of a second section SECT2, insurance B with an insurance premium 120 won/m may be selected. The higher a safety grade of the vehicle, the lower an insurance premium, and the lower a danger level of each segment, the lower an insurance premium.

A danger level of each section may be together displayed on a map displayed in the user terminal 1000 or the vehicle 100.

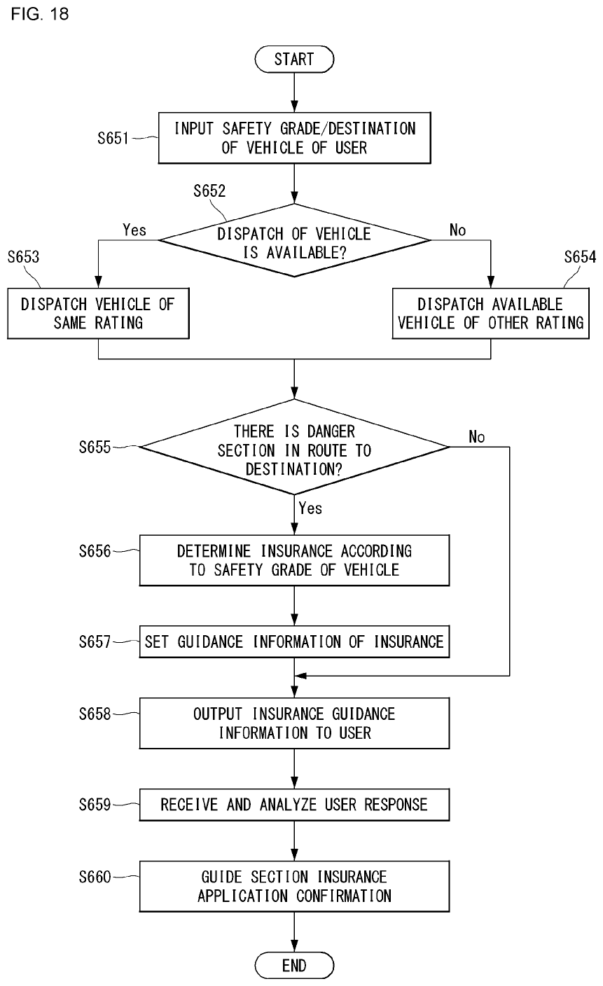

FIG. 18 is a flowchart illustrating a vehicle calling method.

Referring to FIG. 18, the user may input a destination and a safety grade of the vehicle using the user terminal 1000 to call the vehicle 100 (S651).

The server 2000 searches for whether there is an available vehicle 100 based on the destination and the safety grade of the vehicle received from the user terminal 1000. The server 2000 may dispatch a vehicle 100 of a safety grade input by the user or when there is no vehicle of the same safety grade, the server 2000 may guide dispatch of a vehicle of another rating to the user terminal 1000 and dispatch a vehicle of another rating under user determination (S652, S653, and S654).

The server 2000 determines whether there is a danger section in a driving route to the destination (S655). The server 2000 may determine section danger in consideration of various danger factors such as an accident type and an accident rate of each section, weather, a time, and traffic congestion. A weight may be applied to each danger factor, and section danger may be calculated with the sum of danger factors to which a weight is applied.

The server 2000 selects insurance corresponding to a safety grade of a vehicle input by the user and transmits guidance information of the insurance to the user terminal 1000 (S656 and S657). The server 2000 may set insurance guide information including an insurance type and an insurance premium of each section based on a safety grade of the vehicle and section danger.

The user terminal 1000 displays insurance guide information received from the server 2000 on the display (S658). The user may select any one of two or more driving routes received from the server 2000 and select section insurance on the selected driving route.

The server 2000 receives and analyzes a user response to section insurance and calculates a selection ratio and satisfaction of each section insurance. User response analysis may be used as insurance information to be recommended to the user or other users at the same section (S659). The server 2000 transmits a section insurance application confirmation message to the user terminal 1000 and transmits a dispatch command to the vehicle 1000 to enable the vehicle 1000 to move to the user's pickup location. After section insurance is applied, the vehicle 1000 may be driven in a manual mode, an autonomous mode, or a remote control mode in response to a dispatch command of the server 200 to be moved to the user's pickup location (S660).

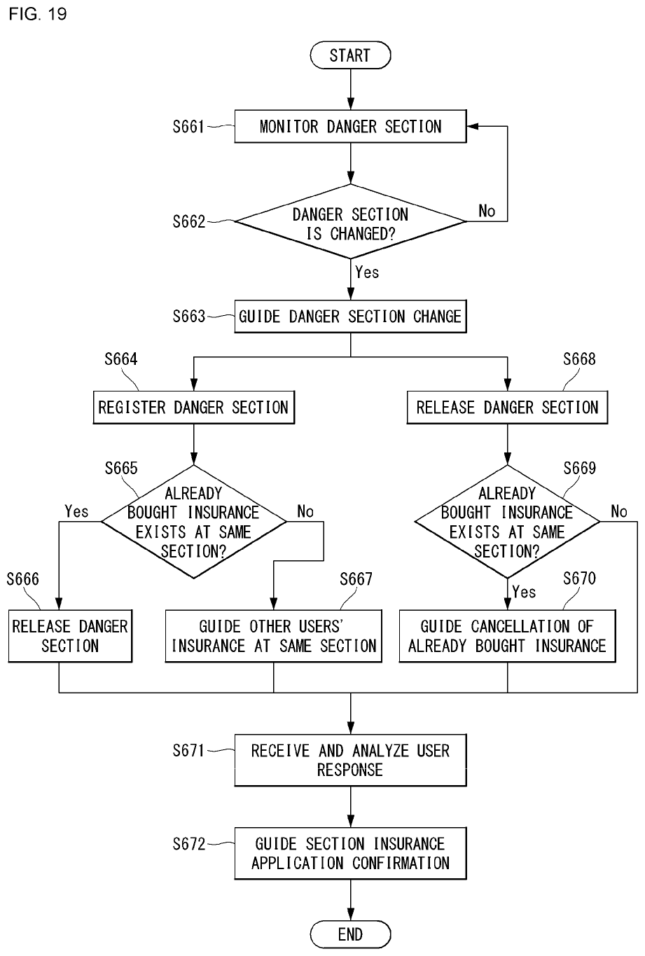

FIG. 19 is a flowchart illustrating a method of guiding insurance when changing a danger section.

Referring to FIG. 19, while driving the vehicle, a danger section on a driving route may be newly registered or cancelled. In this case, the insurance may be cancelled according to a danger change of each section or may be again bought with a danger section insurance premium.

The server 2000 may determine a current position of the vehicle 100 based on vehicle information received from the vehicle 100 while driving the vehicle and monitor a danger section of a driving route in real time (S661).

The server 2000 may receive traffic congestion and weather information received from a National Weather Service server and a police server. When the vehicle number and weather of each section change, the server 2000 may transmit danger section change guidance to the user terminal 1000 and/or the vehicle 100 and register or release a danger section (S663, S664, and S665). The user terminal 1000 or the vehicle 100 may output a danger section change guidance message with a display, a voice, haptic and the like. When the number of vehicles increases or weather becomes worse, danger of the corresponding section increases and thus the corresponding section may be changed to a danger section, and conversely, when the number of vehicles reduces and when weather becomes good, a danger section may be released.

The server 2000 may newly register a danger section. In this case, the server 2000 may transmit a danger section registration message to the user terminal 1000 or the vehicle 100. The user terminal 1000 or the vehicle 100 may output the danger section registration message, for example, “the second section has been newly registered to a danger section due to a weather change.” received from the server 2000.

When the danger section is registered, the server 2000 searches for whether already bought section insurance exists at the same section (S664). The server 2000 searches for whether there is a section insurance history in which the user previously bought at a new danger section. When there is the user's previous insurance record at the new danger section, the server 2000 may transmit information on the insurance to the user terminal 1000 or the vehicle 100 to show previous insurance to the user (S665 and S666). The user terminal 1000 or the vehicle 100 may output a message “An insurance product c has been previously used at the same section. Would you like to use the insurance product c at this time?” to the user in response to the message received from the server 2000.

When there is no user's insurance history at the new danger section, the server 2000 may transmit the most frequent used insurance among insurances bought by other users at the section to the user terminal 1000 or the vehicle 100 to recommend section insurance that may apply to a new insurance section to the user (S667). The user terminal 1000 or the vehicle 100 may output a message “There is no previous record at the same section. Would you like to receive guidance on insurance most frequently used by other passengers at the same section?” to the user in response to the message received from the server 2000.

Upon cancelling a danger section, the server 2000 searches for whether there is already bought insurance by the user at the same section (S668 and S669). In this case, the user terminal 1000 or the vehicle 100 may output a message “A first section has been released from a danger section because of a change of the vehicle number”. to the user in response to the message received from the server 2000.

When there is already bought user's section insurance at a section released from the danger section, the user terminal 1000 or the vehicle 100 may output a message that guides whether insurance cancellation in response to the message received from the server 2000, for example, a message such as “Would you like to cancel insurance of the danger section due to a change in the danger section?” to the user (S670). When the user cancels insurance, the server 2000 may recommend non-danger section insurance to the user.

When there is no insurance bought by the user at a section cancelled from a danger section, the user terminal 1000 or the vehicle 100 may output a message that insurance renewal is not required, for example, a message, “There is no already bought insurance. Driving of the vehicle is maintained.” to the user.

The server 2000 receives and analyzes the user's response to a change in the danger section to calculate a selection rate and satisfaction of section insurance. User response analysis may be used as insurance information recommended to the user or other users at the same section (S671). The vehicle 1000 may continue to drive while receiving section insurance coverage changed while driving (S672).

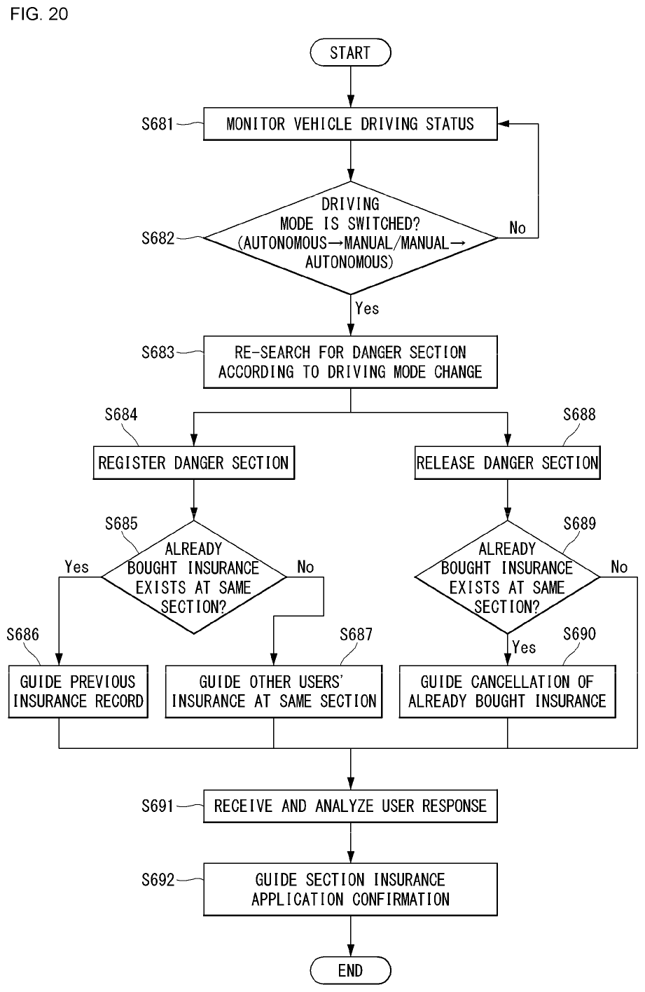

FIG. 20 is a flowchart illustrating a method of guiding insurance when a driving mode of a vehicle is changed.

Referring to FIG. 20, while driving the vehicle, a driving mode may be randomly changed by a user. For example, while driving the vehicle, the user may change a driving mode from a manual mode to an autonomous mode or may change a driving mode from an autonomous mode to a manual mode. A section danger level, an insurance product, and an insurance premium may vary according to a driving mode.

The vehicle 100 may detect that a driving mode is changed to output driving mode change guide, for example, “Manual driving is changed to autonomous driving by an occupant's request. Would you allow the change?” to the user (S681 and S682).

The server 2000 may detect in real time a driving mode change of the vehicle 100 based on vehicle information received from the vehicle 100. When the user accepts a driving mode change, the server 2000 re-searches for a danger section according to the driving mode change (S683).

The user terminal 1000 or the vehicle 100 may guide a danger section and insurance set in the changed driving mode to the user in response to a received message as a re-search result of the server 2000.

The server 2000 may newly register a danger section in the changed driving mode (S684). When registering the danger section, the server 2000 searches for whether already bought section insurance exists at the same section (S685 and S686). When there is the user's previous insurance record at a new danger section, the server 2000 may transmit information on the insurance to the user terminal 1000 or the vehicle 100 to show previous insurance to the user.

When there is no user's insurance history at the new danger section, the server 2000 may transmit most frequently used insurance among insurance bought by other users at the section to the user terminal 1000 or the vehicle 100 to recommend section insurance that may apply to a new insurance section to the user (S687).

The danger section may be released according to a driving mode change (S688). When a danger section is released, the server 2000 searches for whether there is insurance previously bought by the user at the same section (S690).

When there is already bought user's section insurance at a section released from the danger section, the user terminal 1000 or the vehicle 100 may output a message guiding whether insurance cancellation to the user in response to the message received from the server 2000. When the user cancels insurance, the server 2000 may recommend non-danger section insurance to the user.

When there is no insurance bought by the user at a section released from a danger section, the user terminal 1000 or the vehicle 100 may output a message that insurance renewal is not required to the user.

The server 2000 receives and analyzes the user's response to the danger section change to calculate a section insurance selection rate and satisfaction. User response analysis may be used as insurance information to be recommended to the user or other users at the same section (S691). The vehicle 1000 may continue to drive while receiving section insurance coverage changed while driving (S692).

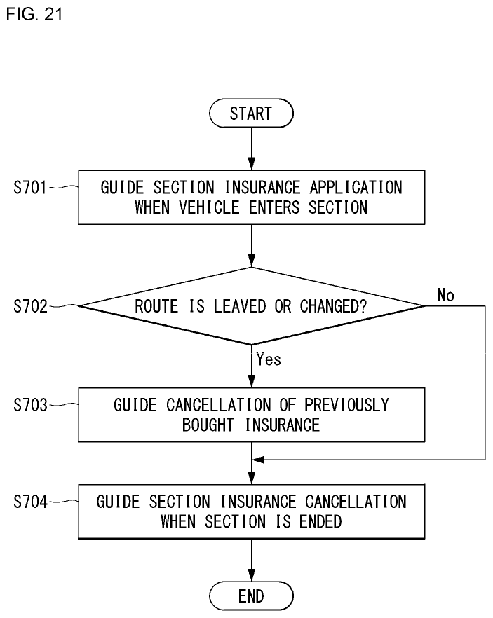

FIG. 21 is a flowchart illustrating an example of an insurance application and cancellation method while driving a vehicle.

Referring to FIG. 21, the server 2000 may determine a current position of the vehicle 100 on a driving route based on vehicle information received in real time from the vehicle 100. When the vehicle 100 enters a section of previously bought section insurance, the server 2000 starts application of the previously bought insurance and notifies the user of this through the user terminal 1000 or the vehicle 100 (S701).

When the corresponding section is ended, the server 2000 cancels insurance of the section and notifies the user of insurance cancellation through the user terminal 1000 or the vehicle 100 (S704).

The user may change a destination or change a driving mode. In this case, the vehicle 100 may leave or change a driving route to leave a section of previously bought insurance (S702). When the vehicle 100 leaves a previously bought insurance section, the server 2000 may output an insurance cancellation message to the user through the user terminal 1000 or the vehicle 100 (S703). The server 2000 may search for an insurance product of a new section according to route leave or change to notify the user of a search result through the user terminal 1000 or the vehicle 100.

An insurance guidance system and method for an autonomous vehicle according to an embodiment of the present invention may be described as follows.

An insurance guidance system of the present invention includes a user terminal for inputting a destination and a safety grade of the vehicle; and a server for transmitting insurance related information of each section of two or more existing sections on a driving route to the destination to the user terminal.

At least one of the user terminal and the vehicle displays a danger section and insurance of each section selected on the driving route.

When the vehicle is driven in an autonomous mode, section insurance is applied to the danger section.

When the vehicle enters a section, the server applies section insurance bought in advance, and when the section is ended, the server cancels the section insurance.

When the vehicle leaves a section of the driving route, the server cancels section insurance bought for the section.

The safety grade of the vehicle is set according to the number and type of safety devices provided in the vehicle.

The safety grade of the vehicle is set according to a resolution and a detection distance of at least one of a camera, radar, lidar (light detection and ranging), an ultrasonic sensor, and an infrared sensor for detecting an external object of the vehicle.

The server monitors in real time at least one of an accident type and an accident rate of each section, weather, a time, and traffic congestion to determine a danger level of each section and sets the danger section according to the danger level of each section.

At least one of the user terminal and the vehicle displays an accident type and an accident rate of the each section.

When at least one of an accident type and an accident rate of the each section, weather, a time, and traffic congestion changes, the server registers or releases the danger section.

When a driving mode of the vehicle is changed from a manual mode to an autonomous mode, the server registers or releases the danger section.

The server transmits recommended section insurance information to at least one of the user terminal and the vehicle based on a section insurance history used by other users. The recommended section insurance information is displayed in at least one of the user terminal and the vehicle.

A method of guiding insurance of the present invention includes inputting a destination and a safety grade of a vehicle to a user terminal; transmitting, by a server, insurance related information of each section of two or more existing sections on a driving route to the destination to the user terminal; and displaying, by at least one of the user terminal and the vehicle, a danger section and insurance of each section selected on the driving route.

When the vehicle is driven in an autonomous mode, section insurance is applied to the danger section.

The insurance guide method further includes applying, by the server, section insurance bought in advance when the vehicle enters a section; and cancelling, by the server, the section insurance when the section is ended during driving of the vehicle.

The insurance guide method further includes cancelling, by the server, section insurance bought for the section when the vehicle leaves a section of the driving route.

A safety grade of the vehicle is set according to the number and type of safety devices provided in the vehicle.

A safety grade of the vehicle is set according to a resolution and a detection distance of at least one of a camera, radar, lidar, an ultrasonic sensor, and an infrared sensor for detecting an external object of the vehicle.

The server monitors in real time at least one of an accident type and an accident rate of each section, weather, a time, and traffic congestion to determine a danger level of each section and sets the danger section according to the danger level of each section.

At least one of the user terminal and the vehicle displays an accident type and an accident rate of the each section.

When at least one of an accident type and an accident rate of the each section, weather, a time, and traffic congestion changes, the server registers or releases the danger section.

When the driving mode of the vehicle is changed from a manual mode to an autonomous mode, the server registers or releases the danger section.

The present invention may be implemented as a computer readable code in a program recording medium. The computer readable medium includes all kinds of record devices that store data that may be read by a computer system. The computer may include a processor or a controller. The detailed description of the specification should not be construed as being limitative from all aspects, but should be construed as being illustrative. The scope of the present invention should be determined by reasonable analysis of the attached claims, and all changes within the equivalent range of the present invention are included in the scope of the present invention.

The features, structures, effects and the like described in the foregoing embodiments are included in at least an embodiment of the present invention and are not necessarily limited to an embodiment. Further, the features, structures, effects and the like illustrated in each embodiment can be combined and modified in other embodiments by those skilled in the art to which the embodiments belong. Therefore, it should be understood that contents related to such combinations and modifications are included in the scope of the present invention.

While the present invention has been described with reference to embodiments, the embodiments are only an illustration and do not limit the present invention, and it will be understood by those skilled in the art that various changes in form and details may be made therein without departing from the spirit and scope of the invention as defined by the appended claims. For example, each component specifically shown in the embodiments can be modified and implemented. It is to be understood that such variations and applications are to be construed as being included within the scope of the present invention as defined by the appended claims.

1. An insurance guidance system for an autonomous vehicle, the insurance guidance system comprising:
a user terminal for inputting a destination and a safety grade of the vehicle; and
a server for transmitting insurance related information of each section of two or more existing sections on a driving route to the destination to the user terminal,
wherein at least one of the user terminal and the vehicle displays a danger section and insurance of each section selected on the driving route.

2. The insurance guidance system of claim 1, wherein section insurance is applied to the danger section when the vehicle is driven in an autonomous mode.

3. The insurance guidance system of claim 1, wherein the server applies section insurance bought in advance when the vehicle enters a section and cancels the section insurance when the section is ended.

4. The insurance guidance system of claim 1, wherein the server cancels section insurance bought for the section when the vehicle leaves a section of the driving route.

5. The insurance guidance system of claim 1, wherein the safety grade of the vehicle is set according to the number and type of safety devices provided in the vehicle.

6. The insurance guidance system of claim 1, wherein the safety grade of the vehicle is set according to a resolution and a detection distance of at least one of a camera, radar, lidar (light detection and ranging), an ultrasonic sensor, and an infrared sensor for detecting an external object of the vehicle.

7. The insurance guidance system of claim 1, wherein the server monitors in real time at least one of an accident type and an accident rate of each section, weather, a time, and traffic congestion to determine a danger level of each section and sets the danger section according to the danger level of each section.

8. The insurance guidance system of claim 1, wherein at least one of the user terminal and the vehicle displays an accident type and an accident rate of the each section.

9. The insurance guidance system of claim 7, wherein the server registers or releases the danger section when at least one of an accident type and an accident rate of the each section, weather, a time, and traffic congestion changes.

10. The insurance guidance system of claim 7, wherein the server registers or releases the danger section when a driving mode of the vehicle is changed from a manual mode to an autonomous mode.

11. The insurance guidance system of claim 1, wherein the server is configured to:
transmit recommended section insurance information to at least one of the user terminal and the vehicle based on a section insurance history used by other users, and
control at least one of the user terminal and the vehicle to display the recommended section insurance information.

12. A method of guiding insurance for an autonomous vehicle, the method comprising:
inputting a destination and a safety grade of the vehicle to a user terminal;
transmitting, by a server, insurance related information of each section of two or more existing sections on a driving route to the destination to the user terminal; and
displaying, by at least one of the user terminal and the vehicle, a danger section and insurance of each section selected on the driving route.

13. The method of claim 12, wherein section insurance is applied to the danger section when the vehicle is driven in an autonomous mode.

14. The method of claim 12, further comprising:
applying, by the server, section insurance bought in advance when the vehicle enters a section; and
cancelling, by the server, the section insurance when the section is ended during driving of the vehicle.

15. The method of claim 12, further comprising cancelling, by the server, section insurance bought for the section when the vehicle leaves a section of the driving route.

16. The method of claim 12, wherein the safety grade of the vehicle is set according to the number and type of safety devices provided in the vehicle.

17. The method of claim 12, wherein the safety grade of the vehicle is set according to a resolution and a detection distance of at least one of a camera, radar, lidar, an ultrasonic sensor, and an infrared sensor for detecting an external object of the vehicle.

18. The method of claim 12, wherein the server monitors in real time at least one of an accident type and an accident rate of each section, weather, a time, and traffic congestion to determine a danger level of each section and sets the danger section according to the danger level of each section.

19. The method of claim 12, wherein at least one of the user terminal and the vehicle displays an accident type and an accident rate of the each section.

20. The method of claim 18, wherein the server registers or releases the danger section when at least one of an accident type and an accident rate of the each section, weather, a time, and traffic congestion changes.
